(19) United States
(12) Patent Application Publication
(10) Pub. No.: US 2011/0214431 A1
(43) Pub. Date: Sep. 8, 2011

(54) TURBINE GUIDE VANE SUPPORT FOR A GAS TURBINE AND METHOD FOR OPERATING A GAS TURBINE

(76) Inventors: Francois Benkler, Ratingen (DE); Andreas Böttcher, Mettmann (DE); Daniel Grundei, Braunschweig (DE); Uwe Lohse, Remscheid (DE); Ekkehard Maldfeld, Mulheim an der Ruhr (DE); Mirko Milazar, Oberhausen (DE); Oliver Schneider, Wesel (DE); Shilun Sheng, Oberhausen (DE)

(21) Appl. No.: 13/060,774

(22) PCT Filed: Aug. 17, 2009
(86) PCT No.: PCT/EP2009/060598

§ 371 Date: May 17, 2011

(30) Foreign Application Priority Data
Aug. 27, 2008 (EP) 08015129.3

(51) Int. Cl. F02C 7/12

(52) U.S. Cl. 60/772; 60/806

(57) ABSTRACT

A turbine guide vane support for an axial-flow gas turbine is provided. The support includes a tubular wall having an inflow-side end and an outflow-side end for a hot gas flowing in the interior of the turbine guide vane support in a flow path of the gas turbine. Cooling channels for a coolant are provided in the wall. The cooling channels extend from a coolant inlet to a coolant outlet, respectively. At least one of the cooling inlets and one of the cooling outlets, respectively, is disposed at the outflow-side end of the turbine guide vane support, wherein the cooling channel associated with the respective inlet and outlet extends up to the inflow-side end of the turbine guide vane support and transitions to a redirecting area from which the respective cooling channel further extends to the outflow-side end.

### CROSS REFERENCE TO RELATED APPLICATIONS

This application is the US National Stage of International Application No. PCT/EP2009/060598 filed Aug. 17, 2009, and claims the benefit thereof. The International Application claims the benefits of European Patent Application. No. 08015129.3 EP filed Aug. 27, 2008. All of the applications are incorporated by reference herein in their entirety.

### FIELD OF INVENTION

The invention relates to a turbine guide vane support for a gas turbine, comprising a tubular wall, having an inflow end and an outflow end, which is at the opposite end from the inflow end, for a hot gas flowing in the interior of the turbine guide vane support. The invention also relates to a method for operating a gas turbine.

### BACKGROUND OF INVENTION

A turbine guide vane support of the type described in the introduction for a stationary gas turbine is presently in principle formed from two identical semi-tubular support elements which in principle form a tube space by being screwed together in flanged fashion. On their inner surfaces there are grooves, which run along the periphery, for receiving and securing guide vanes of the turbine unit of the gas turbine.

The turbine unit of the gas turbine also has a flow path of increasing cross section along the axial extent; the external diameter of this flow path also increases continuously. The airfoils of the turbine guide vanes, which are secured to the inside of the turbine guide vane support, project into the flow path. On account of the flow path diameter increasing in the axial direction, the turbine guide vane support of a gas turbine of this type is also of corresponding configuration, i.e. with a diameter which on average increases continuously in the direction of flow. It is therefore of conical configuration. A guide vane support of the type described in the introduction always has an inflow end and an outflow end for the hot gas, as seen in its direction of flow through the flow path of the turbine section. The inflow end of the turbine guide vane support, which is annular in cross section, has a smaller radius than the radius of the outflow end.

At the inflow end of the turbine guide vane support, the hot gas generated in the combustion chamber is guided into the annular flow path of the gas turbine, which extends in the axial direction through the interior of the turbine guide vane support. The flow path carries the hot gas that is fed in to the outflow end of the turbine guide vane support. During this process, the hot gas expands in the flow path, generating work at the turbine guide vanes and releasing heat to its surroundings. Moreover, the temperature of the hot gas is further reduced by the supply of cooling air. This is known to result in higher entry temperatures than exit temperatures for the hot gas.

This leads to material temperatures in the turbine guide vane support that are significantly higher at the inflow end than at its outflow end, resulting in a temperature gradient being established in the axial direction of the turbine guide vane support, leading to different thermal stresses and different thermal expansions.

However, general trends in the direction of further increased turbine entry temperatures lead to further thermal and mechanical stresses on the housing components of the gas turbine and in particular the turbine guide vane support. This also increases the temperature gradient. To achieve a sufficient service life for the turbine guide vane support for a gas turbine with further increased entry temperatures, it may be necessary to change the material from which the turbine guide vane support is made, since the material must be able to withstand the higher temperatures over a prolonged period of time. However, materials with a higher heat resistance are usually significantly more expensive than less heat-resistant conventional materials.

For aircraft gas turbines, the use of more expensive materials for the turbine guide vane support can be avoided by them being laterally cooled by means of axially flowing cooling air, as is known for example from EP 1 004 759 A2 and WO 92/17686 A1. A locally increased cooling effect is provided in those axial sections of the turbine guide vane support at which the hook-fitting connections for guide vanes are provided. For this purpose, in EP 1 004 759 A2, turbulators which run all the way around the circumference are provided, and in WO 92/7686 A1 narrowed flow cross sections are provided. However, these arrangements cannot be deployed on stationary gas turbines, since an axial cooling air flow on the lateral side is not possible on account of the existence of separate chambers for cooling air of different pressures.

Furthermore, various ways of cooling guide ring segments are disclosed in EP 0 974 734 A2, EP 1 213 444 A2 and GB 2 378 730 A.

### SUMMARY OF INVENTION

Therefore, it is an object of the invention to provide a turbine guide vane support for a stationary gas turbine which can continue to be manufactured from a relatively inexpensive material under even more onerous temperature conditions. A further object of the invention is to provide an efficient method for cooling gas turbine components.

The objects are achieved by a turbine guide vane support and by a method according to the independent claims.

The invention is based on the discovery that the critical locations for the thermal expansion and also for the compressive stresses are located at the front of the guide vane support, i.e. at the inflow end. Moreover, it has been discovered that the coolant that is used to cool the guide vanes of one turbine stage, for example the fourth turbine stage, can be used before that to cool the turbine guide vane support without thereby impairing the cooling, functioning and service life of the guide vanes of the turbine stage in question.

To cool the turbine guide vane support, it is necessary for at least one cooling channel for a coolant, in each case extending from a coolant inlet to a coolant outlet, to be provided in the wall that at least partially forms the turbine guide vane support.

Therefore, according to the invention, the cooling channel that connects the inlet to the outlet extends in the axial direction from the inlet to a diverting region arranged at the inflow end of the turbine guide vane support and, from there, extends onward to the outlet.

The invention therefore consists in the coolant that is usually used to cool the guide vanes arranged in the downstream part of the turbine guide vane support or to block gaps that are present there between components also to cool the warmest region of the turbine guide vane support, namely the inflow end. The coolant that is intended to cool the turbine guide vanes of the fourth turbine stage is preferably first of all passed through cooling channels arranged in the turbine guide vane support, in order to cool its inflow region, in which the highest thermal stresses occur. After it has cooled the inflow region of the turbine guide vane support, the coolant is guided back toward the outflow end of the turbine guide vane support. From there, it is guided inward to an antechamber that is arranged in the interior between the inner surface of the turbine guide vane support and the guide vanes secured there. Then, the coolant can flow into the guide vanes themselves and cool them. As an alternative or in addition the coolant can also be used to block the gaps that are present there. Since the required cooling for the turbine guide vanes of the rear stages is less extensive than for the front guide vanes, and the cooling capacity of the coolant there has not previously been fully utilized, a certain increase in the temperature of the coolant can be accepted without problems, without having to significantly change the turbine guide vane design and without risk of insufficient cooling. According to the invention, however, the coolant that is intended to cool the guide vanes of the second or third turbine stage can also be passed through the cooling channels upstream—based on the hot gas flow direction—in order to cool the guide vane support.

As a result of the cooling of the turbine guide vane support at the inflow end, the thermal stresses there can be reduced. Moreover, as a result of the thermal energy being carried away to the outflow end of the turbine guide vane support with the aid of the coolant, this end is at least slightly heated. Although this increases the hitherto lower thermal stresses at the outflow end, these stresses in any case overall remain within the permissible stress levels. This in particular results in a more even thermal stress over the axial extent of the turbine guide vane support. The temperature gradient is reduced.

As a result of this suitable temperature control of the turbine guide vane support, it is possible to make do without the use of a material with a high temperature resistance. This allows better utilization of the material, reducing costs.

A further advantage of the above-described active temperature control can also occur during the transient start-up and shut-down mode, namely when controlled cooling is acting on the system dynamics of the gas turbine in such a manner as to achieve gap optimization during this operating phase. At the same time, the transient properties of the gas turbine can be improved by virtue of the turbine guide vane support being heated up and cooled down more quickly and more evenly.

For existing gas turbines, it is only necessary to change the design of the turbine guide vane support in order to prepare them for higher temperatures.

A multiplicity of cooling channels according to the invention is distributed over the periphery of the wall. The inlets of these cooling passages are expediently arranged at an outer surface of the wall, the supply of coolant through the turbine guide vane support usually taking place from the outside, which means that arranging the cooling air inlet at the outer surface of the turbine guide vane support wall, which is tubular in cross section, is expedient.

Advantageous configurations are given in the dependent claims.

Since the coolant flowing through the turbine guide vane support is generally used to cool turbine guide vanes arranged inside the turbine guide vane support and/or to block gaps that are present there, it is advantageous if the outlets are arranged as a hole at an inner surface of the wall. This in particular makes it easy to discharge the coolant to its subsequent location of use.

Particularly efficient heat transfer can be achieved if turbulators, which further mix the cooling air flowing in the cooling channel, are arranged on at least one cooling channel wall.

Preferably, a groove is provided in an outer surface of the wall of the turbine guide vane support for each cooling channel, which groove is for the most part closed off by a cover so as to form the associated cooling channel. If the coolant inlet is not also provided at the cover, the cover can close off the entire cooling channel.

The cooling channels that extend from the outflow end to the inflow end of the turbine guide vane support and back again can be cast into the outer contour of the turbine guide vane support, which is cast as a single piece. This meandering channel shape is thus relatively simple and inexpensive to produce.

The channels are then preferably closed off by covers with the exception of the inlets. For this purpose, the covers are welded in a gastight manner to the turbine guide vane support. The cover is expediently formed as a metal cover plate. If necessary, these plate-like covers can support a supply port forming the inlet for the coolant into the cooling channel.

The invention can be used in particular for conical turbine guide vane supports which are formed from two semi-tubular guide vane support elements that are in turn screwed together in flanged fashion. This division into two identical guide vane support elements is particularly advantageous for stationary gas turbines, which generally have a parting plane running parallel to the horizontal plane.

According to a further advantageous configuration of the invention, the inner surface of the turbine guide vane support is configured in such a manner that guide vanes of a turbine unit of the gas turbine which are arranged in a ring can be secured to it. Expediently, grooves, into which the guide vanes of the turbine can be hooked or pushed, extend circumferentially at the inner surface.

### BRIEF DESCRIPTION OF THE DRAWINGS

The invention is explained with reference to a drawing; further features and further advantages will emerge from the description. In the drawing:

FIG. 1 shows a perspective, diagrammatic view of a turbine guide vane support according to the invention for a stationary gas turbine,

FIG. 2 shows a longitudinal section through the turbine guide vane support according to the invention shown in FIG. 1, on section line II-II, and

FIG. 3 shows a longitudinal section through the turbine guide vane support according to the invention as shown in FIG. 1, on section line

### DETAILED DESCRIPTION OF INVENTION

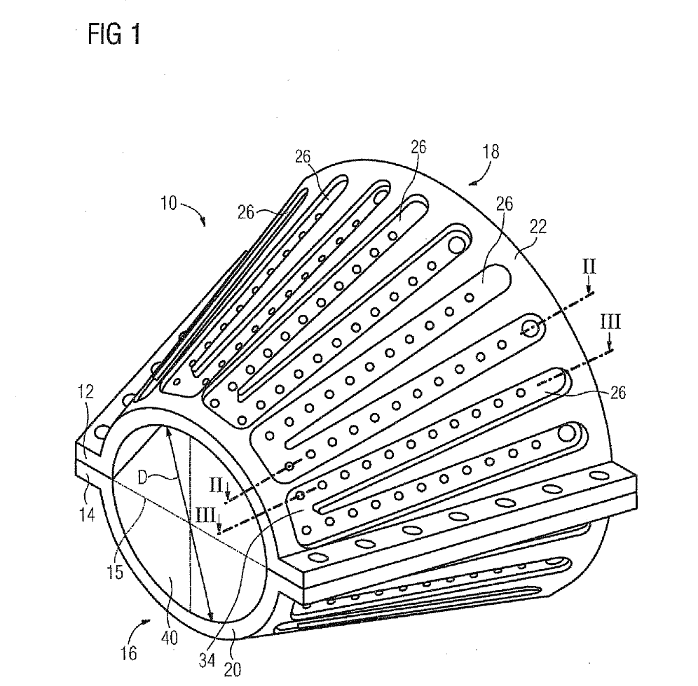

FIG. 1 shows a perspective, diagrammatic illustration of a turbine guide vane support 10 for a stationary, axial-flow gas turbine. Features of the turbine guide vane support 10 that are not relevant to the invention are not shown in the figures. The turbine guide vane support 10 is formed from two semi-tubular guide vane support elements 12, 14, the guide vane support element 12 forming the top half of the turbine guide vane support 10 and the guide vane support element 14 forming its bottom half.

The guide vane support elements 12, 14 are flanged together in a parting plane 15.

The turbine guide vane support 10 has an axial extent and is of conical configuration along this extent. Accordingly, the tubular guide vane support 10 has a first end 16 and a second end 18 at the opposite end from the first end 16. The inner diameter D of the first end 16 is significantly smaller than the internal diameter of the second end 18. The same is true of the external diameter.

When used in a stationary gas turbine, the turbine guide vane support 10 is arranged in a pressure casing of the gas turbine, in such a manner that the first end 16 lies opposite the outlet of a combustion chamber (not shown in more detail). The second end 18 of the turbine guide vane support 10 then lies opposite an exit diffusor (not shown) of the gas turbine.

A flow path, which is delimited on the radially outer and radially inner side by suitable elements, i.e. platforms of turbine blades and/or vanes and guide rings, extends axially within an interior 40 enclosed by the turbine guide vane support 10. These elements are not shown in FIG. 1 for the sake of clarity; the same applies to the flow path, which is annular in cross section inside the turbine guide vane support 10, for the hot gas generated in the combustion chamber. Based on the hot gas and its direction of flow, the first end 16 of the turbine guide vane support 10 is the inflow end 16 and the second end 18 is the outflow end 18.

The turbine guide vane support 10 is schematically formed by a tubular wall 20. A plurality of cooling channels 26, which are distributed over the periphery, are arranged on the outer surface 22 of said tubular wall 20, i.e. on the outer lateral surface of the two semi-tubular guide vane support elements 12, 14. The illustration presented in FIG. 1 shows the cooling channels 26 arranged in the wall 20, but without the covers that are ordinarily arranged above the cooling channels 26. Each of the cooling channels 26 extends in a U-shape: they extend from a coolant inlet 32 to the inflow end 16, located upstream thereof, of the turbine guide vane support 10. There, each cooling channel 26 merges into a diverting region 34, from which the cooling channel 26 then extends back toward the outlet 36. In the exemplary embodiment illustrated, the inlet 32 and the outlet 36 are both arranged at the outflow end 18, i.e. in the region of the rear turbine stage. Inlet 32 and outlet 36 may however also be arranged in the region of the middle turbine stages.

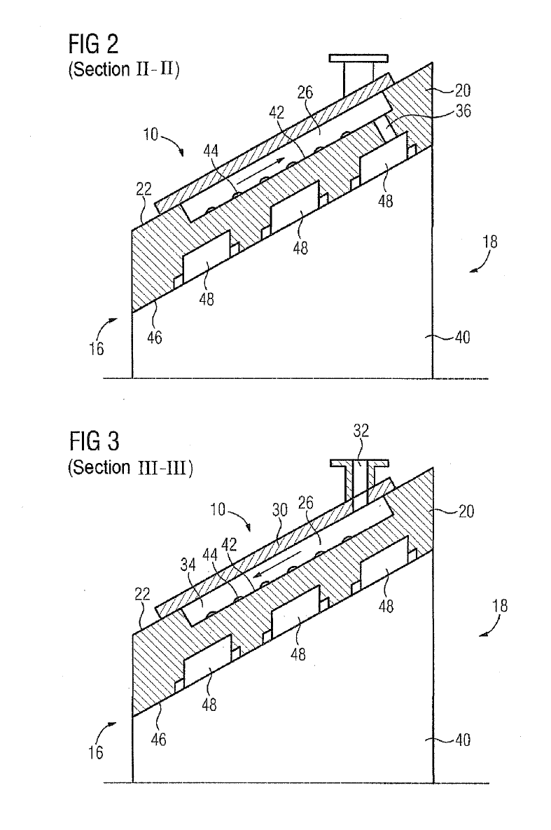

FIG. 3 shows the section through the turbine guide vane support 10 shown in FIG. 1. The cover 30, which is not illustrated in FIG. 1 is however shown in FIG. 2 and FIG. 3. The cooling channel 26, which is otherwise open toward the outside, is for the most part closed off by means of the cover 30, with the exception of the inlet 32, through which a coolant, preferably cooling air, can be fed to the cooling channel 26. The inlet 32 is arranged at the outflow end 18 of the turbine guide vane support 10.

The coolant supplied through the inlet 32 flows along the cooling channel 26 to the inflow end 16, where it then cools the turbine guide vane support 10, in particular near the diverting region 34. After it has flowed through the diverting region 34, it flows toward the outflow end 18 in the subsequent cooling channel section. The section of the cooling channel 26 which follows the diverting region 34 is illustrated in FIG. 2. The coolant can be discharged inward from the cooling channel 26 through the outlet 36 arranged at the outflow end 18. Before doing so, however, the heated coolant warms up the rear region of the turbine guide vane support 10, resulting in a more even temperature along the axial direction. The outlet 36 passes the coolant into the interior 40 surrounded by the turbine guide vane support 10, from where it can be used for further cooling of turbine guide vanes secured in the rear region of the turbine guide vane support 10. Alternatively, the coolant can also be used to block gaps that are present there. Blocking the gaps is in this context understood as meaning that coolant is blown from the gaps into the hot gas flow path, in order to prevent hot gas being drawn into gaps, which would damage components forming the gap.

While a gas turbine having a turbine guide vane support 10 configured in accordance with the invention is operating, the thermal energy produced in the front, i.e. inflow-side, end 16 of the turbine guide vane support 10 can be particularly efficiently dissipated by the coolant flowing in the wall 20 after it has been fed to the cooling channel 26 through the inlet 32. After it has cooled the inflow end 16 of the turbine guide vane support 10, the cooling air is passed into the interior 40 via the outflow end 18 of the turbine guide vane support.

To this extent, the coolant is not, as previously, passed through the turbine guide vane support 10 via the shortest radial route from the outside inward, but rather covers a cooling loop. The meandering cooling loop passes the coolant from the cooler region of the turbine guide vane support 10—the outflow end 18—to a warmer region—the inflow end 18—and back. The rear, outflow region of the guide vane support is warmed by the coolant that has been heated up during the cooling of the front region of the guide vane support. This results in more even thermal stresses in the axial direction of the turbine guide vane support 10, giving an overall reduction in the peak thermal stresses. This makes it possible to use a relatively inexpensive material for the turbine guide vane support 10 despite a further increase in the ambient temperature of the turbine guide vane support 10 resulting from higher turbine entry temperatures.

If necessary or expedient, the wall 42 that delimits the cooling channel 26 on the radially inner side may also be equipped with turbulators 44 in order to improve the heat transfer. This then leads to a relatively efficient heat transfer from the turbine guide vane support 10 into the coolant and vice versa.

Moreover, circumferentially endless grooves 48, in which guide vanes of various turbine stages can be fitted and secured, are provided at the inner surface 46 of the turbine guide vane support 10. However, these grooves 48 are only very schematically illustrated.

Overall, the invention relates to a turbine guide vane support 10 for an axial-flow gas turbine comprising a tubular wall 20, having an inflow end 16 and an outflow end 18 for a hot gas flowing in a gas turbine flow path in the interior 40 of the turbine guide vane support 10, wherein at least one cooling channel 26 for a coolant, which in each case extends from a coolant inlet 32 to a coolant outlet 36, is provided in the wall 20. To design the turbine guide vane support 10 for particularly high use temperatures, it is proposed that the inlet 32 and the outlet 36 are each arranged at the outflow end 18 of the turbine guide vane support 10, while the cooling channel 26 associated with the respective inlet 32 and outlet 36 extends toward the inflow end 16 of the turbine guide vane support 10, where it merges into a diverting region 34, from where it extends back toward the outflow end 18.

1.-10. (canceled)

11. A turbine guide vane support for a gas turbine, comprising:
a tubular wall with an inflow end and an outflow end, the outflow end being at an opposite end from the inflow end;
an interior for a hot gas flowing in a flow path of the turbine guide vane support;
a plurality of cooling channels for a coolant located in the tubular wall, wherein the cooling channels are distributed over a periphery, each cooling channel extending from a coolant inlet to a coolant outlet,
wherein the cooling inlet is arranged at the outflow end of the turbine guide vane support,
wherein the cooling outlet is arranged at the outflow end of the turbine guide vane support, and
wherein each cooling channel
connects the cooling inlet to the cooling outlet,
extends in an axial direction from the cooling inlet to a diversion region, which is arranged at the inflow end of the turbine guide vane support, and
extends in the axial direction from the diversion region back to the cooling outlet.

12. The turbine guide vane support as claimed in claim 11, wherein at least one of the cooling inlets is arranged at an outer surface of the wall.

13. The turbine guide vane support as claimed in claim 11, wherein at least one of the cooling outlets is arranged at an inner surface of the wall.

14. The turbine guide vane support as claimed in claim. 12, wherein at least one of the cooling outlets is arranged at an inner surface of the wall.

15. The turbine guide vane support as claimed in claim 11, further comprising: turbulators arranged on at least one cooling channel wall.

16. The turbine guide vane support as claimed in claim 11, further comprising:
a groove in an outer surface of the tubular wall for each cooling channel,
wherein the groove is for the most part closed off by a cover so as to faun the associated cooling channel.

17. The turbine guide vane support as claimed in claim 11, wherein the guide vane support
is of conical configuration, and
is formed from two semi-tubular guide vane support elements, which are connected to one another in a flanged manner.

18. The turbine guide vane support as claimed in claim 11, wherein the guide vane support comprises, at an inner surface, circumferentially running grooves for securing guide vanes of a turbine that are arranged in a ring.

19. A gas turbine, comprising:
a casing, the casing comprising a turbine guide vane support as claimed in claim 11.

20. The gas turbine as claimed in claim 19, wherein at least one of the cooling inlets is arranged at an outer surface of the wall.

21. The gas turbine as claimed in claim 19, wherein at least one of the cooling outlets is arranged at an inner surface of the wall.

22. The gas turbine as claimed in claim 19, further comprising:
turbulators arranged on at least one cooling channel wall.

23. The gas turbine as claimed in claim 19, further comprising:
a groove in an outer surface of the tubular wall for each cooling channel,
wherein the groove is for the most part closed off by a cover so as to form the associated cooling channel.

24. The gas turbine as claimed in claim 19, wherein the guide vane support
is of conical configuration, and
is formed from two semi-tubular guide vane support elements, which are connected to one another in a flanged manner.

25. The gas turbine as claimed in claim 19, wherein the guide vane support comprises, at an inner surface, circumferentially running grooves for securing guide vanes of a turbine that are arranged in a ring.

26. A method of operating a gas turbine, comprising:
providing and using a coolant
for cooling turbine blades and/or vanes or wall segments, and/or
for blocking gaps which open out in a hot gas path,
wherein the coolant cools a turbine guide vane support
before the coolant cools the turbine blades and/or vanes or wall segments, and/or
before the coolant blocks the gaps.

27. The method as claimed in claim 20, wherein a section of the turbine guide vane support is cooled which is arranged axially upstream of the turbine blades and/or vanes, wall segments and/or gaps.
